(19) United States
(12) Patent Application Publication
(10) Pub. No.: US 2012/0319835 A1
(43) Pub. Date: Dec. 20, 2012

(54) Device and Method for Electronic Body Monitoring, more particularly for Infants

(75) Inventors: Ulrich Schulmeister, Bietigheim-Bissingen (DE); Dieter Schwarzmann, Heilbronn (DE); Nik Scharmann, Bietigheim-Bissingen (DE); Friedrich Meichert, Gera (DE)

(73) Assignee: Robert Bosch GmbH, Stuttgart (DE)

(21) Appl. No.: 13/494,943

(22) Filed: Jun. 12, 2012

(30) Foreign Application Priority Data
Jun. 15, 2011 (DE) 10 2011 077 515.3

(51) Int. Cl. G08B 1/08

(52) U.S. Cl. 340/539.12

(57) ABSTRACT

A device for electronic body monitoring, more particularly for infants, is disclosed. The device has a sensor part and a signaling part. The sensor part has a sensor apparatus for monitoring parameters of an infant, a fixation apparatus for affixing the sensor part to the infant and a first radio interface. The device includes an evaluation apparatus for evaluating the sensor signals and for triggering an alarm. The signaling part has a signaling apparatus for signaling the alarm and a second radio interface, which can at least receive data transmitted by the first radio interface.

This application claims priority under 35 U.S.C. §119 to patent application no. DE 10 2011 077 515.3, filed on Jun. 15, 2011 in Germany, the disclosure of which is incorporated herein by reference in its entirety.

The present disclosure relates to a device and a method for electronic body monitoring, more particularly for infants.

### BACKGROUND

Sudden infant death syndrome is one of the most common ways of dying in child age beyond the neonatal period. Currently, one way of taking precautions against sudden infant death syndrome lies in using motion detectors, e.g. Angelcare AC401, http://www.angelcare.de. Here, motion is captured by sensor mats situated below a mattress. In the case of motion detectors for taking precautions against sudden infant death syndrome, the motion of the child is monitored, and a warning signal is transmitted in the case of a relatively long break between movements. In this case, no further vital parameters of the child are monitored in addition to motion.

EP 0 573 765 B1 discloses a method and a device for monitoring the change in the motion state of objects or parts of the human body by means of an arrangement of optical fibers. DE 10 2008 014 652 A1 discloses a medical detection device for detecting sleep apnea or sleep hypopnea on the basis of sound. DE 10 2009 001 398 A1 discloses a plaster for detecting movements of a body.

A further way of taking precautions against sudden infant death syndrome lies in using cardio-respiratory monitors. In this case, the respiration rate is permanently monitored by a body sensor and the heart rate is permanently monitored using two electrodes. Body sensor and electrodes are connected to monitoring equipment by cables. Cardio-respiratory monitors monitor the heart rate of the infant with the aid of electrodes and monitor the respiratory movement of the infant with the aid of a body sensor. If critical values are reached in the process, e.g. a respiratory pause of more than 15 seconds, the parents are informed by means of an alarm function.

Plasters comprising electronic components, for example for monitoring human vital parameters, are referred to as electronic functional plasters. Known applications of electronic plasters include measuring EKGs or blood-oxygen saturation.

An electronic functional plaster comprises electronics for signal processing and control, optionally sensors, actuators and output elements, which are integrated in an adhesive plaster. An autonomous energy source, e.g. a battery, is required for supplying the electronic components with electrical energy.

### SUMMARY

The present disclosure provides a device and a method for electronic body monitoring according to claims 1 and 13, respectively, more particularly for infants, in order to identify critical states of the infant, which could lead to sudden infant death syndrome, in good time and trigger an alarm.

The preferred embodiment of the disclosure has a functional plaster.

Preferred developments are the subject matter of the dependent claims.

According to the disclosure, the combination of different sensor systems in addition to monitoring various vital parameters of an infant also allows the monitoring of further important parameters in respect of the risk of infant death syndrome.

The following come into question as vital parameters to be monitored: heart rate, skin temperature, respiration rate and movement. The sleep position—supine, lateral or prone position—the ambient temperature and the ambient humidity can be measured as further parameters.

By monitoring the measured parameters and comparing these to intended value ranges for each parameter, it is possible to achieve improved identification of critical states of the infant.

Simplified handling is achieved by embedding the electronics into a plaster.

### BRIEF DESCRIPTION OF THE DRAWINGS

FIG. 1 shows a schematic illustration of a device for electronic body monitoring, more particularly for infants, with a sensor part on an infant and a signaling part next to it, as per one embodiment of the present disclosure.

FIG. 2 shows a schematic illustration of a sensor apparatus of a sensor part as per one embodiment of the present disclosure.

FIG. 3 schematically shows a sensor part with the functional group from FIG. 2 in one embodiment as functional plaster.

FIG. 4 shows a schematic external view of a signaling part as per one embodiment of the present disclosure.

FIG. 5 shows a schematic illustration of functional elements of the signaling part from FIG. 4.

FIG. 6 shows a schematic illustration of a signaling unit from a multiple monitoring apparatus for a multiplicity of devices for electronic body monitoring, more particularly for infants, as per one embodiment of the present disclosure.

FIG. 7 shows a flowchart of the method for electronic body monitoring, more particularly for infants, as per one embodiment of the present disclosure.

### DETAILED DESCRIPTION

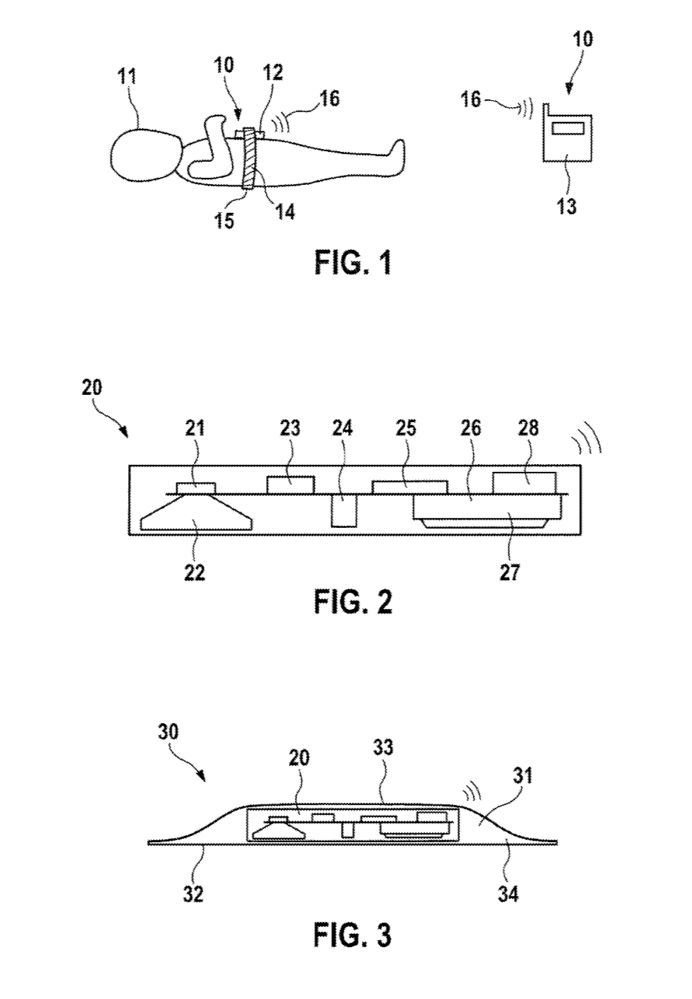

FIG. 1 illustrates a device 10 for electronic body monitoring, more particularly for infants, as per one embodiment of the present disclosure, with a sensor part 12 affixed to an infant 11 and a signaling part 13 next to it. The sensor part 12 has a fixation apparatus 14, in this example an elastic band—the rubber band 15.

The fixation device is designed such that it is used to affix the sensor part 12 to the infant body. Alternatively, this can preferably be brought about by securely adhering the sensor part 12 by means of an adhesive plaster or an adhesive tape strip. As an alternative to this, fixation by means of an already present diaper of the infant may also be advantageous. Moreover, there may be integration into a pacifier.

FIG. 1 visualizes the device 10 as a two-part system, which consists of the sensor part 12, with a sensor apparatus for measuring the parameters of the infant 11, and the signaling part 13 for signaling parameters of the infant 11 captured by means of the sensor apparatus and for alerting the parents. During operation, the sensor part 12 uses sensors to monitor the infant 11 and transmits monitoring data to the signaling part 13 by means of radio waves 16. The device 10 comprises an evaluation apparatus for evaluating the sensor signals and for triggering an alarm. The sensor part 12 has a fixation device 14 for affixing the sensor part 12 to the infant 11. The signaling part 13 can be arranged at a distance from the infant 11 such that the parents can reliably perceive an alarm. The sensor apparatus has a first radio interface and the signaling part has a second radio interface, which can at least receive data transmitted by the first radio interface.

FIG. 2 illustrates a sensor apparatus 20 of a sensor part, such as the sensor part 12 from FIG. 1, as a functional group. The sensor apparatus 20 has an acoustic sensor 21 with an acoustic horn 22, an accelerometer 23, a temperature sensor 24, an evaluation logic unit 25, an energy source 26, in this case a battery 27, and transmission electronics 28.

Hence, the sensor apparatus 20 contains various sensors 21, 23, 24 for measuring the parameters and the sleep position of the infant, an evaluation logic unit 25 for processing the sensor signals and transmission electronics 27 for transmitting data to the signaling part, and also an electric energy source 26 for supplying the electronics with energy. The contained energy source can be designed such that it is rechargeable or replaceable.

In order to measure heart beat and respiration, use is made of an acoustic sensor 21, a microphone, in conjunction with an acoustic horn. In order to measure the sleep position and movement of the infant, use is made of the accelerometer 23. The skin temperature is captured by a temperature sensor 24, as used in medical thermometers.

In order to evaluate and process the sensor signals, use is made of the evaluation logic unit 25. The latter can be realized by a microcontroller or a programmable logic component, e.g. FPGA, PAL or GAL.

In order to transmit the data from the sensor apparatus 20 to the signaling part 13, the transmission electronics 27 are used here for wireless transmission of the data, for example by means of WLAN, Bluetooth or RFID.

Here, a simple button cell serves as energy source 26 for the electronics. The holder of the battery should then be designed such that it is easy to replace the latter. The use of a rechargeable battery is an alternative thereto. The rechargeable battery can then be charged either by contact surfaces, for example on a plaster, or, in the case of an appropriate configuration, in a contactless manner by means of an induction field.

FIG. 3 illustrates a sensor part 30 with the sensor apparatus 20 from FIG. 2 in a preferred embodiment as functional plaster 31. In addition to the sensor apparatus 20, the functional plaster 31 has an adhesive layer 32 and a cover layer 33. An electronic functional plaster 31, which is affixed directly to the infant, is created by embedding the sensor apparatus 20 into an adhesive plaster 34 as fixation device. Here, the functional plaster 31 is designed such that the adhesive layer can be replaced in a simple manner, in order to enable multiple use. As an alternative, a plurality of adhesive plasters with a pocket are available, and the sensor apparatus 20 can be inserted into these.

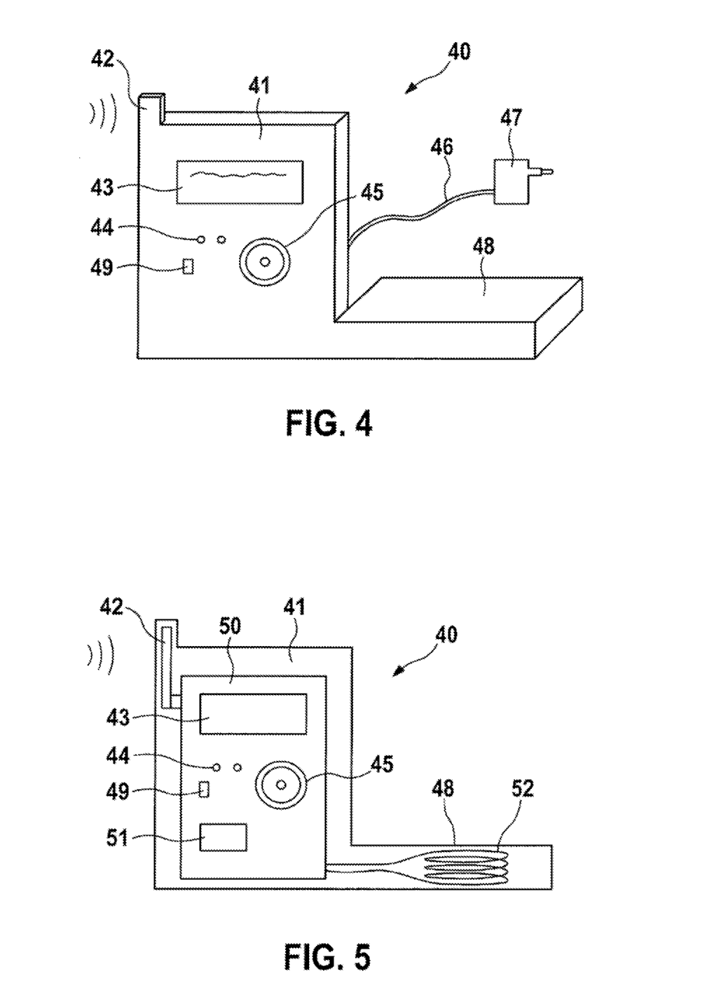

FIG. 4 shows an external view of a signaling part 40 as per one embodiment of the present disclosure. Arranged externally on a housing 41, there is an antenna 42 for data reception, a graphics display 43 for displaying data, two LEDs 44 as optical warning elements and a loudspeaker 45 as acoustic warning element. For energy supply purposes, the signaling part 40 is connected to a plug-in power supply unit 47 via a cable 46. The signaling part 40 furthermore has a storage space 48 for a sensor part like the sensor part 30 from FIG. 3. In the case of sensor parts with rechargeable battery, the storage space 48 serves as a charge area for charging the rechargeable battery of the sensor part by means of induction. The signaling part 40 furthermore has a thermometer with a temperature sensor 49, routed to the outside, for measuring the ambient air temperature. The signaling part 40 optionally has a hygrometer (not illustrated) with an ambient air humidity sensor, routed to the outside, for measuring the ambient humidity.

FIG. 5 shows functional elements of the signaling part 40 from FIG. 4. A printed circuit board 50 is arranged within the housing 41 of the signaling part 40. The printed circuit board 50 carries the elements: display 43, LEDs 44, loudspeaker 45 and temperature sensor 49, which are known from FIG. 4. The printed circuit board 50 furthermore carries control, reception and evaluation electronics 51. A coil 52, which is connected to the printed circuit board 50, for charging a rechargeable battery in a sensor part by induction is likewise situated within the housing 41. The printed circuit board 50 furthermore has the connections (not illustrated) of the elements that are situated on the printed circuit board 50 or connected to the printed circuit board 50.

As an alternative to the plug-in power supply unit 47, the reception device can be supplied with electrical energy from a battery.

The control, reception and evaluation electronics 51 are designed such that they can receive the data transmitted by a sensor part, for example by means of WLAN, Bluetooth or RFID. The control, reception and evaluation electronics 51 serve to evaluate the received data and control the signaler and warning elements. Here, the evaluation electronics may consist of a microcontroller and/or a programmable logic component.

The warning elements LEDs 44 and loudspeaker 45 serve to warn the parents if there is a risk of sudden infant death syndrome.

As signaling element, the signaling part 40 contains the display 43 for visualizing the data transmitted by a sensor part: heart rate, skin temperature, respiration rate, movement and sleep position. In addition to the current data record, the display can also signal the time profile of the data. In the shown embodiment of the signaler, the LEDs 44 serve to signal problem-free functioning of the device for electronic body monitoring, more particularly for infants, and for signaling an alarm.

Alternatively, signaling the data signaled in the display can be realized by simple LEDs.

A charging apparatus, coil 52 in FIG. 5, in the signaling part 40 serves to charge the rechargeable battery if a rechargeable battery is used in the sensor part. Depending on the embodiment of the energy source of the sensor apparatus 20, the charging apparatus can have a socket with appropriate electric contacts as an alternative to the coil 52. The storage space 48 as a charge area can have a marking as a positioning aid for charging the sensor part by means of induction.

As an alternative to an independent signaling part, it is possible to use an appropriately equipped PC, e.g. with WLAN receiver, Bluetooth receiver or USB receiver, for receiving the data from the sensor part, with appropriate software as signaling part.

By processing all available data, in particular the sleep position, in the evaluation logic unit of the sensor part, it is possible to achieve improved identification of critical states, which could lead to sudden infant death syndrome.

The data measured on the infant is evaluated in the sensor part in all of the above-described examples. An advantage of this is that processed data, and therefore data that is reduced in terms of its amount, is transmitted. Alternatively, sensor data that has not been completely processed can be transmitted by the sensor part, and said data is evaluated in the signaling part.

According to a further embodiment of the disclosure, the signaling part 40 furthermore has an Internet connection. As a result, remote monitoring of the child can take place when requested, independently of an emergency, for example by means of an Internet-capable cellular telephone.

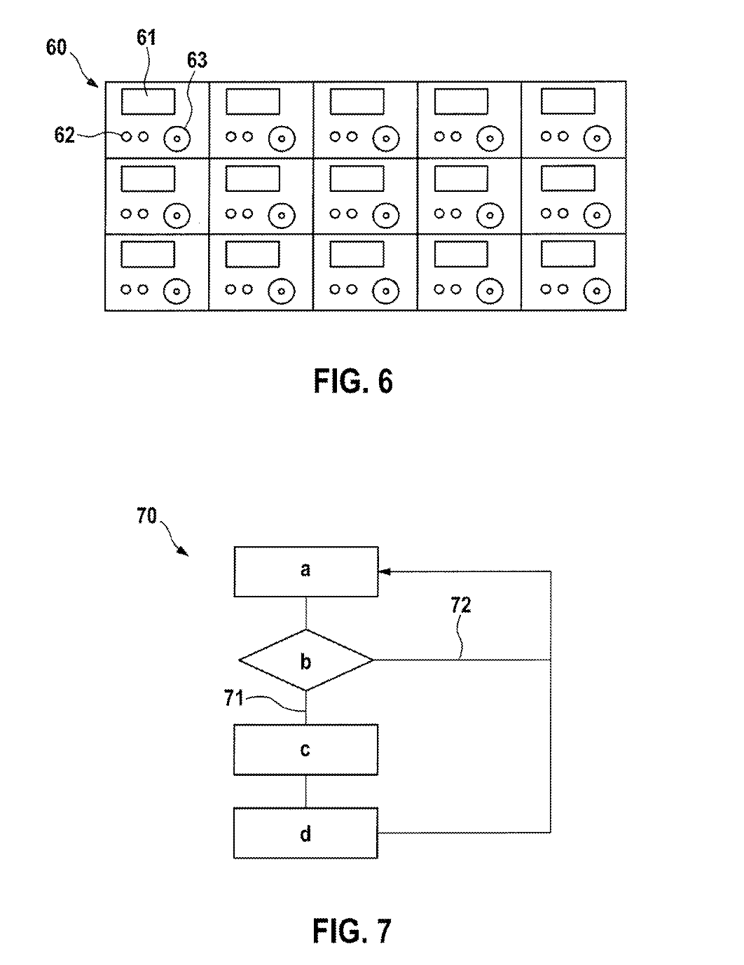

FIG. 6 shows a signaling unit 60 of a signaling part of a multiple monitoring apparatus for a multiplicity of sensor parts for electronic body monitoring, more particularly for infants, as per one embodiment of the present disclosure. The signaling unit 60 serves for monitoring a plurality of children within the scope of hospital use. For each sensor part, the signaling unit 60 has a graphics display 61 for illustrating data, two LEDs 62 as optical warning elements and a loudspeaker 63 as acoustic warning element. In order to use one signaling part for a plurality of sensor parts, the control, reception and evaluation electronics, and also the warning and signaling elements, are multiplied. Here, various signaling parts with a different number of channels can be made available. The individual sensor parts are identified according to the respective data transmission variant used.

FIG. 7 shows a flowchart 70 of the method for electronic body monitoring, more particularly for infants, according to one embodiment of the present disclosure. The method for electronic body monitoring, more particularly for infants, starts with method step a): measuring measurement values in respect of parameters of the infant. This is followed in method step b) by a comparison of the measurement values with an intended range of the corresponding parameter.

If at least one measurement value lies outside of the intended range of the corresponding parameter, an alarm is then emitted in method step c) via branch 71. In method step d), the alarm and the at least one measurement value that lies outside of the intended range are signaled. The method then repeats again, starting with method step a). If it is not the case that at least one measurement value lies outside of the intended range for the intended parameter, a repetition of the method, starting with method step a), follows directly via branch 72.

As per one embodiment of the disclosure, after method step a), a check is carried out in the method as to whether there is an external query in respect of transmitting measurement values and, if need be, the measurement values are transmitted to the external source. By way of example, this embodiment is possible in the case of a signaling part with an Internet connection. As a result, the child can be monitored remotely following a query by the parents, independently of an emergency, for example by means of an Internet-capable cellular telephone. The cellular telephone transmits, via the Internet, a query in respect of transmitting measurement values to the signaling part. The signaling part thereupon transmits the measurement values to the cellular telephone over the Internet. The query and the transmission of the measurement values are preferably encrypted with the necessary data security. The additional function can be designed as a separately installable program for the cellular telephone.

What is claimed is:

1. A device for electronic monitoring of a body, comprising:
a sensor part having a sensor apparatus configured to monitor parameters of the body, a fixation apparatus configured to affix the sensor part to the body, and a first radio interface,
a signaling part, and
an evaluation apparatus configured to evaluate the sensor signals and to trigger an alarm,
wherein the signaling part includes a signaling apparatus configured to signal the alarm and a second radio interface configured to at least receive data transmitted by the first radio interface.

2. The device according to claim 1, wherein the sensor apparatus has sensors configured to monitor one or more of the following vital parameters of the body: heart rate, skin temperature, respiration rate and movement.

3. The device according to claim 1, wherein the sensor apparatus has at least one sensor configured to monitor at least one of the following parameters of the body: lying position and body temperature.

4. The device according to claim 1, wherein the fixation apparatus has an adhesive strip.

5. The device according to claim 1, wherein the sensor part is configured as functional plaster.

6. The device according to claim 1, wherein the fixation apparatus has an elastic band.

7. The device according to claim 1, wherein the sensor part supports the evaluation apparatus.

8. The device according to claim 1, wherein the signaling part supports the evaluation apparatus.

9. The device according to claim 1, wherein the sensor part has a rechargeable battery and the signaling part has a charging station for the sensor part.

10. The device according to claim 1, wherein the signaling part has an optical and/or acoustic signaler for the alarm.

11. The device according to claim 1, wherein the signaling part has a signaling apparatus for signaling parameters captured by the sensor apparatus.

12. The device according to claim 1, wherein:
the signaling part has a signaling unit of a multiple monitoring apparatus for a multiplicity of sensor parts for electronic monitoring, and
the signaling unit has, for each sensor part, a graphics display and a signaling apparatus configured to signal the alarm.

13. The device according to claim 1, wherein the signaling part has an Internet connection.

14. A method for electronic monitoring of a body, comprising:
a) measuring measurement values in respect of parameters of the body;
b) comparing the measurement values with an intended range of the corresponding parameter;
if at least one measurement value lies outside of the intended range:
c) emitting an alarm; and
d) signaling the at least one measurement value that lies outside of the intended range.

15. The method according to claim 14, further comprising:
after step a), a check is carried out as to whether there is an external query in respect of transmitting measurement values and, if need be, transmitting the measurement values to the external source.
